(19) United States
(12) Patent Application Publication
(10) Pub. No.: US 2002/0130142 A1
(43) Pub. Date: Sep. 19, 2002

(54) Windshield washer fluid dispenser

(76) Inventor: Loyde A. Wheeler, Spokane, WA (US)

Correspondence Address: JAMES L. PRICE, AT WELLS, ST. JOHN, ROBERTS, GREGORY & MATKIN P.S, 601 W. FIRST AVENUE, SUITE 1300, SPOKANE, WA, 99201-3838, US

(21) Appl. No.: 09/813,045

(22) Filed: Mar. 19, 2001

(51) Int. Cl. B67D 5/38

(52) U.S. Cl. 222/158; 222/2; 222/318; 222/424; 222/71; 222/21

(57) ABSTRACT

A windshield washing fluid dispenser is described for selectively filling a vehicle windshield washer reservoir. A base housing supports a windshield washing fluid tower which is at least partially transparent to visually display windshield washing fluid therein. A bulk windshield washing fluid container is situated within the base housing. A fluid pump assembly has an intake line received within the fluid container and a discharge line that extends to openly communicate with the display tower. The pump assembly is operable to at least partially fill the display tower to a selected level such that the windshield washing fluid is visible through the windshield washing fluid display tower. A filler hose leads from the display tower to a discharge end, the hose being of sufficient length to extend from the windshield washer fluid display tower to the vehicle windshield washer reservoir.

### TECHNICAL FIELD

The present invention relates to the delivery of windshield washing fluid and more particularly to a bulk windshield washing fluid dispenser having a fluid display tower.

### BACKGROUND OF THE INVENTION

Vehicles including cars, trucks, vans, and the like typically have windshield washing fluid reservoirs and pumps that can be selectively activated to spray water or a washing solution on the vehicle windshield to work in conjunction with the vehicle windshield wipers to clean or otherwise remove particulate matter from the outer surface of the windshield.

The reservoirs vary in their respective volume or capacity but typically will contain at least a quart of the cleaner or washing fluid. The fluid supply will diminish with use and the vehicle operator often finds that the fluid has been totally depleted at an inappropriate time. Under these circumstances an operator usually makes a special trip to a retail outlet where the windshield washing fluid is sold, and secures one-gallon containers. The amount of fluid in these containers is typically more than the vehicle reservoir will hold, so after filling the reservoir, the operator will either dispense of the container and remaining surplus windshield washing fluid, or find a place to store the excess.

When the supply of windshield washing cleaner is depleted, the vehicle user must either buy more fluid in another container, or use the surplus from the previous purchase. In the former event, the user is now saddled with two containers. In the latter event, there may not be enough surplus fluid to fill the vehicle reservoir and the time to the next fill is reduced.

It is typically unusual that a full windshield washer fluid reservoir will become fully depleted between fuel fillings. Thus, if the vehicle operator had access to windshield washer fluid each time the vehicle is taken in for refueling, the washer reservoir would not likely become depleted at an inappropriate time.

A need has therefor been seen for a windshield washing fluid dispenser that can be associated with a fuel filling station. The present invention fills this need, as will be understood from the following description and accompanying drawings.

### BRIEF DESCRIPTION OF THE DRAWINGS

Preferred embodiments of the invention are described below with reference to the following accompanying drawings.

FIG. 1 is a frontal elevation view of a preferred windshield washing fluid dispenser;

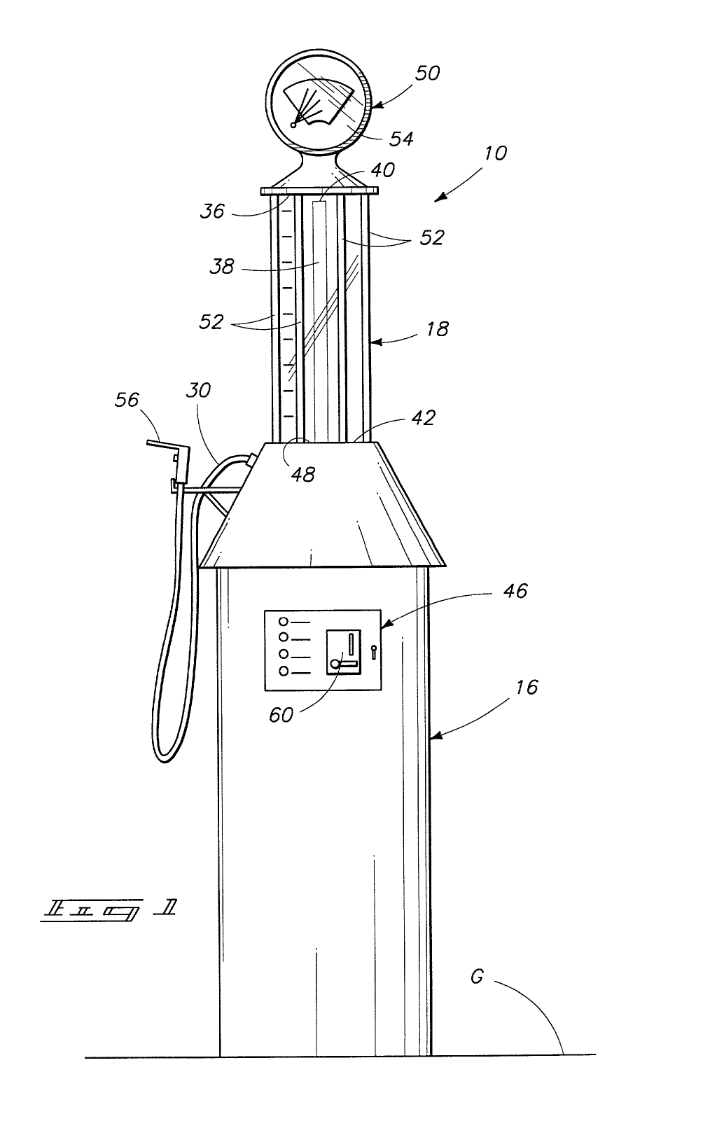

FIG. 2 is a view similar to FIG. 1 and only showing portions thereof in a cross sectional view;

FIG. 3 is an enlarged fragmented view;

FIG. 4 is a sectional view taken substantially along line 4-4 in FIG. 3;

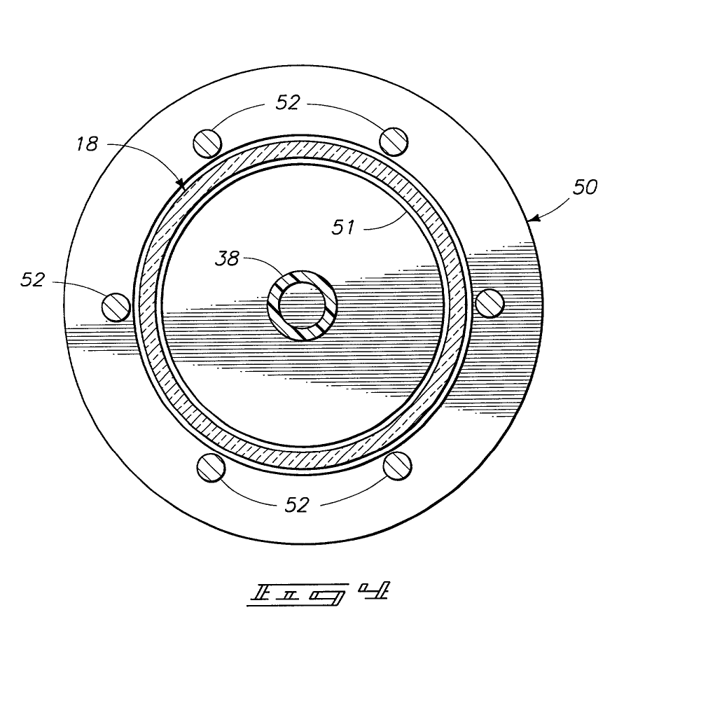

FIG. 5 is a perspective view of the dispenser shown in FIG. 1; and

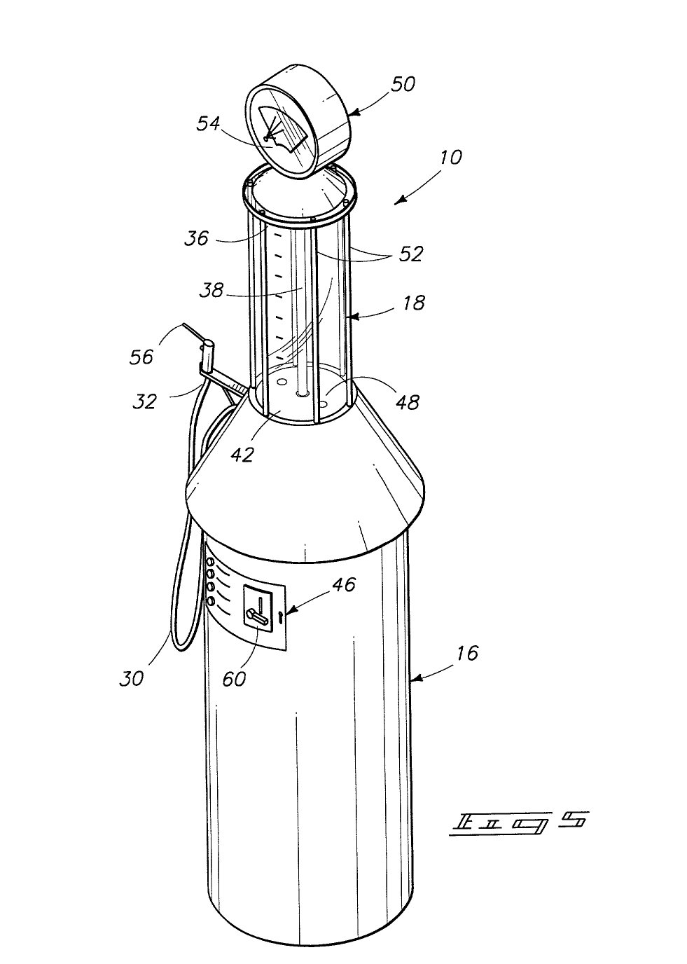

FIG. 6 is a schematic view illustrating operation of the dispenser and controls for such operation.

### DESCRIPTION OF PREFERRED EMBODIMENTS

This disclosure of the invention is submitted in furtherance of the constitutional purposes of the U.S. Patent Laws “to promote the progress of science and useful arts” (Article 1, Section 8).

General Description

Before relating specific details of preferred elements of the invention, general statements describing preferred aspects of the invention will be given.

A first aspect of the invention includes a windshield washing fluid dispenser 10 for selectively filling a vehicle windshield washer reservoir 12, including a base housing 16. A windshield washing fluid display tower 18 is provided on the base housing 16, and which projects upwardly therefrom and which is at least partially transparent to visually display windshield washing fluid 20 therein. A bulk windshield washing fluid container 22 is situated or otherwise enclosed within the base housing 16. A fluid pump assembly 24 with an intake line 26 is received within the fluid container 22. The fluid pump further has a discharge line 28 extending to openly communicate with the windshield washing fluid display tower 18. The pump assembly 24 is operable to at least partially fill the fluid display tower 18 with windshield washing fluid 20 from the fluid container 22 to a selected level such that the windshield washing fluid 20 is visible through the windshield washing fluid display tower 18. A filler hose 30 leads from the windshield washer fluid display tower 18 to a discharge end 32, the hose 30 being of sufficient length to extend from the windshield washer fluid display tower 18 to the vehicle windshield washer reservoir 12.

Another aspect of the invention involves a process for dispensing windshield washing fluid 20 directly to a vehicle 14 having a windshield washing reservoir 12. The process includes a first step of locating a windshield washing fluid display tower 18 on a base housing 16 at an elevation above the vehicle windshield washing reservoir 12. Further steps include supplying the fluid display tower 18 with windshield washing fluid 20 from a container 22 which is enclosed within the base housing 16 and visually displaying the windshield washing fluid 20 in the fluid display tower 18. Further steps include locating a filler hose 30 that leads from the windshield washer fluid display tower 18 to a discharge end 32 and extending the hose 30 from the windshield washer fluid display tower 18 to the vehicle windshield washer reservoir 12, and then opening a valve 34 to permit the flow of windshield washer fluid 20 from the fluid display tower container and into the vehicle fluid reservoir 12.

In another aspect of the invention, a windshield washing fluid dispenser 10 is provided for selectively filling a vehicle windshield washer reservoir 12, and which includes a hollow base housing 16, and a windshield washing fluid display tower 18 comprised of an elongated cylindrical and at least substantially transparent tube mounted on the base housing and projecting upwardly therefrom to a top end 36. A bulk windshield washing fluid container 22 is removably mounted below the display tower 18 within the base housing 16. A fluid pump assembly 24 is mounted within the base housing 16, and includes an intake line 26 that is receivable within the fluid container 22, and a discharge line 28 that extends to openly communicate with the windshield washing fluid display tower 18. The pump assembly 24 is operable to at least partially fill the fluid display tower 18 with windshield washing fluid 20 from the fluid container 22 to a selected level such that the windshield washing fluid is visible through the windshield washing fluid display tower. An overflow tube 38 is substantially centrally located within the display tower 18 with a top end 40 adjacent the display tower top end 36, and a bottom end 42 receivable within the fluid container. A filler hose 30 leads from the windshield washer fluid display tower 18 to a discharge end 32. The hose 30 is of sufficient length to extend from the windshield washer fluid display tower 18 to the vehicle windshield washer reservoir 12. A valve 34 in the filler hose 30 is selectively operable to permit flow of windshield cleaner fluid 20 from the washing fluid display tower 18 and into a vehicle washer fluid reservoir 12. The washing fluid display tower 18 is positioned by the base housing 16 at an elevation between approximately 4 and 6 feet, from a dispenser support surface G such that the windshield washing fluid 20 will flow by gravity from the display tower 18 to a vehicle windshield washer reservoir 12.

Detailed Description

Given the above generalized descriptions, various elements of preferred embodiments will now be discussed in greater detail.

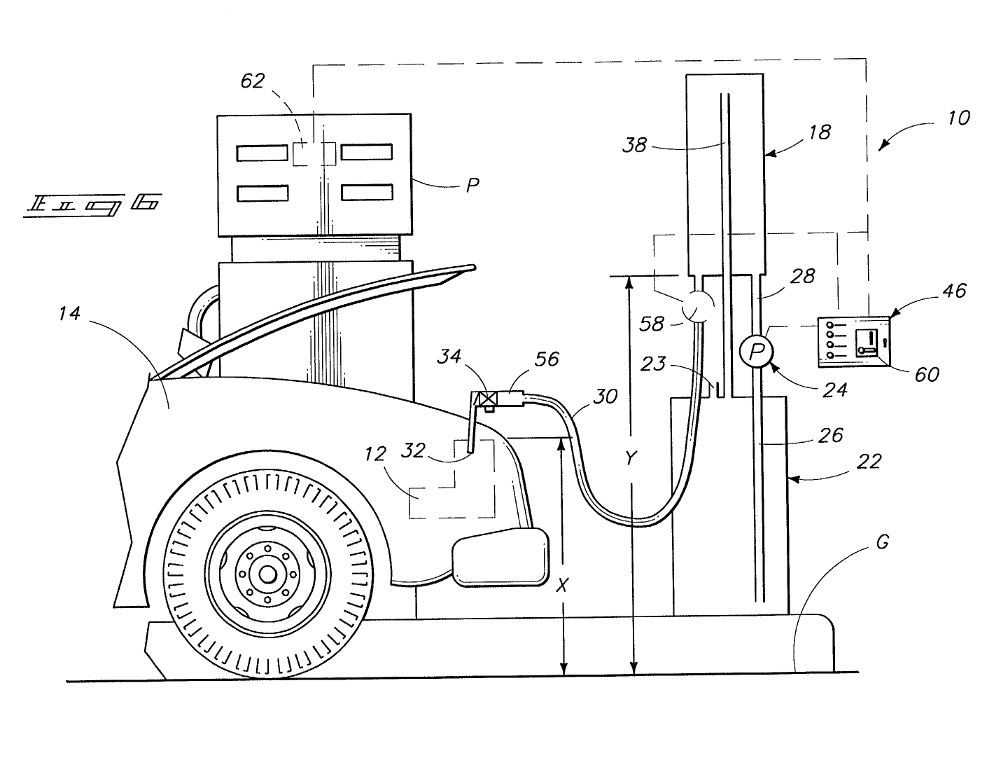

The base housing 16 is illustrated as substantially circular, and hollow to enclose the fluid container 22, pump assembly 24 and at least portions of a control system 46. The housing 16 could also be oval, rectangular, rectilinear or other shapes without departing from the scope of the invention. Preferably, the housing 16 is constructed of an appropriate sheet metal or materials commonly used in construction of conventional “gas station” fuel pump housings. In this regard, any rigid material which is resistant to hydrocarbon fuels could be employed. It is preferable that a top platform 48 of the housing be at a minimal distance Y from the ground or support surface G (FIG. 6) in order that the fluid display tower be situated elevationally above the height X of a windshield washer fluid reservoir 12 in most standard vehicles. Thus, the preferred range of height for the platform top is approximately 4-6 feet, and preferably at about 5 feet.

The container 22 is preferably a separate element from the housing 16, although it could be made integral with the housing walls. The preferred container 22 rests or is enclosed within the bottom portion of the housing, and is formed of an appropriate plastic material that is complementary to the cross-sectional shape of the housing. The container may be designed to hold a large volume of windshield washer fluid (approximately 30 gallons) to service a large number of vehicles before requiring refilling or replacement with a full container. A top surface of the container may include access openings for the pump intake line 26, the bottom end of the overflow tube 38, and a vent 23.

The fluid display tower 18 projects upwardly from the base housing and, as indicated above, is preferably substantially transparent or translucent to allow visual confirmation of the presence of the windshield washer fluid. In one form of the invention, the tower is fabricated of transparent or translucent pipe or tubing that is approximately 8 inches in diameter and 18 inches in height. These dimensions permit a total fluid storage content within the tower of approximately 3 gallons below the intake opening of the overflow tube 38. The height of the tower adds to the column height for the fluid, and assures appropriate gravity flow through the filler hose 30, if gravity flow is used for purposes of delivering the fluid.

It should be understood that the tower 18 is provided not only as an elevated reservoir for the washing fluid, but also provides an interesting and appealing point of purchase visual display for a potential purchaser. The tower thus provides a significant added advantage of visually displaying and promoting sale of the windshield washing fluid, especially when the apparatus is placed in a location which is adjacent to fuel pumps in an automotive refueling station.

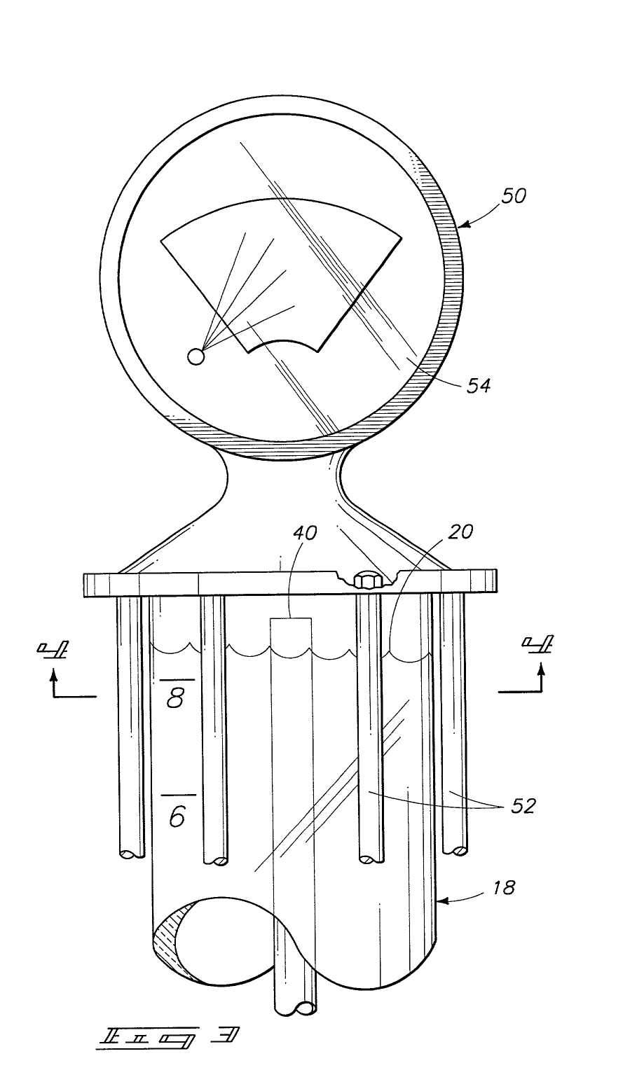

In the present invention, a cap structure 50 is provided on the display tower 18, and which seals the top end 36 of the upright tubular configuration. The cap 50 may also be provided with a gasket 51 (FIG. 3) to seal against the tower top 36. A similar gasket (not shown) may be provided at the tower bottom. The gaskets may be formed of conventional gasket material such as rubber, to seal the tower interior. These gaskets should resist degradation when exposed to hydrocarbons. Steel rods 52 may be provided in spaced relation about the tower, joining the cap 50 and base housing 16 to secure the tower against the gaskets. The rods may be threaded at ends to receive clamp nuts (one being shown in FIG. 3).

The top portion of cap 50 may be provided with a display surface 54 that may be used as an advertising space which identifies the contents of the tower; or which has an associated fuel station logo; or whatever the owner desires. The illustrated shape of the display surface 54 is circular, but other shapes may be used with equal success. Further, opposite sides of the cap may include similar display surfaces, with a lamp or other light source (not shown) positioned between the surfaces for back lighting purposes if desired.

It is preferable to provide volume indicia on a surface of the tower 19. Such indicia may be provided to indicate units of measure such as quarts or liters and, if further desired, subdivisions may be indicated as well. The markings may be placed by conventional printing or marking processes on the outside or inside surfaces of the tubular tower structure. The markings may be used to indicate how much fluid has been dispensed through the filler hose 30.

Windshield washer fluid 20 is delivered to the tower 18 by operation of the pump assembly 24, which preferably includes a conventional electric pump that is mounted within the housing 16. The intake line 26 has a bottom or lowermost end that may be releasably received in fluid with drawing relation within the container 22, and a top or uppermost end that is connected in fluid flowing relation to the intake side of the pump. It may be preferable that the line 26 be removable from the container, to facilitate easy independent removal of the various pump components and container (if desired) from the housing 16 for maintenance or replacement.

The discharge line 28, leading from the discharge side of the pump, extends through the top platform 48 on the housing and into the tower 18. Operation of the pump may thus serve to fill the tower with windshield washer fluid 20 to the level of the overflow tube 38.

The overflow tube 38 is located within the tower and substantially coaxially oriented with the tubular axis thereof. It extends to the top end 40, which is spaced just below the tower top end 36. The tube 38 is normally rigid and self supporting. The substantial central, coaxial orientation of the overflow tube is selected for visual appeal, since the windshield washer fluid 20 within the tower is substantially transparent.

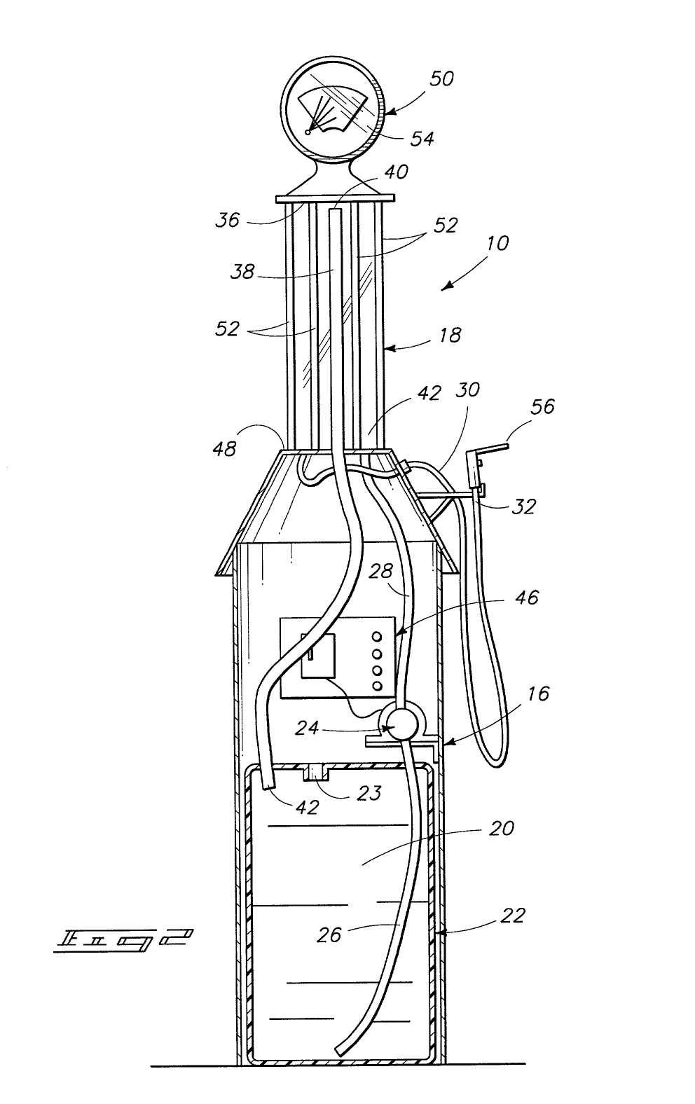

Excess fluid 20 within the tower may be drained by the overflow tube 38 back into the container 22 through the bottom tube end 42 as shown in FIG. 2. The bottom end 42 may be releasably received in the container to facilitate disassembly and removal of the container or tower from the base housing.

Fluid is selectively drained from the tower through the filler hose 30, which is preferably of a sufficient length to reach the windshield washer reservoir 12 of a vehicle parked adjacent the apparatus 10. It is expected that a hose length of approximately 7-10 feet may be sufficient, though other lengths may be used with equal success. For example, longer hose lengths may be desirable in a filling station installation where it may be desirable for the hose to extend to permit simultaneous access to the present apparatus and to an adjacent fuel filling pump. Installations in other locations, for example, at a car wash or parts retailer may dictate other hose lengths.

A conventional filler nozzle 56 may be provided at an end of the filler hose 30. The nozzle may be appropriately valved, using the valve 34 which is a commercially available, manually operable valve, that is similar to those used by fuel filling stations. The valve 34 may include a conventional pressure sensor that will automatically close the valve 34 upon sensing that the vehicle fluid reservoir 12 is full.

It should be understood that although gravity flow is shown as a preferred manner for discharging fluid from the tower 18, discharge by other means could be used. For example, a “T” plumbing fitting (not shown) could be placed in the filler line 30, with direct fluid connection to the pump. Under the arrangement, fluid could be simultaneously discharged to the filler hose 30 and to the tower. Alternatively, the filler hose could be valved to receive fluid either from the tower or the pump depending upon the elevation of the nozzle. Other alternatives may be used as well with equal success.

FIG. 6 shows, in schematic form, a preferred installation for the present apparatus next to a conventional filling station pump P, which will typically provide fuel to a vehicle in quantities that are metered and visually displayed to the user. The present apparatus may include conventional coin-operated activation 60 that may be mounted on the housing; or control could be tied by an ancillary control 62 to the operation of the associated fuel pump P

In another form of the invention, a metering device 58 could be provided in the filler hose line 30, with a signal output being sent to the internal price calculator and display of the associated fuel pump P, so the fuel pump will display a combined total cost of fuel and windshield washer fluid. The user would then pay the total amount (for fuel and washer fluid) shown on the fuel pump display. The control 58 may be made such that no fuel purchase becomes necessary, yet any dispensed windshield washer fluid will be indicated on an associated fuel pump and charges will appear according to the amount of fluid taken.

It is also possible for the present assembly to be activated by a conventional credit card scanner, so charges could be made against the card for the amount of fluid delivered. This arrangement could also be coupled with credit card fuel purchases.

Of course, the present apparatus could be provided with no metering or fee calculations, as may be desirable in installations where there is no need to collect charges for the windshield washer fluid. Private garages or commercial fleet owners could make use of such units.

In operation, a user may suitably activate the system depending upon the charge or billing system used. For example, insertion of a select number of coins could trigger operation of the pump 24 for a select amount of time that would equate to a prescribed volume of windshield washer fluid 20. That amount of fluid could be pumped into the display tower 18, then drained as the user operates the filler hose valve 34. Once the reservoir 12 fills, the conventional sensor in the filler nozzle 56 will close the valve and stop flow of fluid. An appropriate metering device 58 in the filler hose could measure the amount of dispensed fluid and compare that amount to the amount paid for, then dispense change if need be.

In another example, as where the present apparatus is connected to a conventional metering and charging system of a conventional fuel filling pump P, appropriate controls would be provided so the user may simply fill a vehicle reservoir 12 using the nozzle 56 and the charges would be added to whatever fuel purchase was registered on the associated fuel pump.

In a further example, operation of the present system could be integrated with a conventional credit card purchase systems that are currently in use at fueling stations. The card could simply substitute for the coin activation arrangement described above.

In any of the operational situations described above, and equivalents thereof, it is advantageous for the user in that the amount of washer fluid purchased may be the exact amount needed to fill the reservoir R. Further, if the apparatus is installed at a filling station, the purchaser may attend to filling the washer reservoir while refueling.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A windshield washing fluid dispenser for selectively filling a vehicle windshield washer reservoir, comprising:
a base housing;
a windshield washing fluid display tower on the base housing, projecting upwardly therefrom and which is at least partially transparent to visually display windshield washing fluid therein;
a bulk windshield washing fluid container within the base housing;
a fluid pump assembly with an intake line received within the fluid container and a discharge line extending to openly communicate with the windshield washing fluid display tower, and operable to at least partially fill the fluid display tower with windshield washing fluid from the fluid container to a selected level such that the windshield washing fluid is visible through the windshield washing fluid display tower; and
a filler hose leading from the windshield washer fluid display tower to a discharge end thereof, the hose being of sufficient length to extend from the windshield washer fluid display tower to the vehicle windshield washer reservoir.

2. The windshield washing fluid dispenser for selectively filling a vehicle windshield washer reservoir, as defined by claim 1, wherein the container is removable from the base housing.

3. The windshield washing fluid dispenser for selectively filling a vehicle windshield washer reservoir, as defined by claim 1, wherein the filler hose includes a remote discharge end and a valve adjacent the remote discharge end and which is selectively operable between an open windshield washer fluid delivery condition and a closed windshield washer fluid retention condition.

4. The windshield washing fluid dispenser for selectively filling a vehicle windshield washer reservoir, as defined by claim 1, further comprising a selected volume of windshield washing fluid contained within the fluid container.

5. The windshield washing fluid dispenser for selectively filling a vehicle windshield washer reservoir, as defined by claim 1, further comprising an overflow return fluid line opening into the fluid container and the fluid display tower.

6. The windshield washing fluid dispenser for selectively filling a vehicle windshield washer reservoir, as defined by claim 1, wherein the fluid display tower is substantially transparent and of an upright tubular configuration.

7. The windshield washing fluid dispenser for selectively filling a vehicle windshield washer reservoir, as defined by claim 1, wherein the fluid display tower is substantially transparent and of an upright tubular configuration and includes volume indicia on a surface thereof.

8. The windshield washing fluid dispenser for selectively filling a vehicle windshield washer reservoir, as defined by claim 1, wherein the fluid display tower is substantially transparent and of an upright tubular configuration; and further comprising a cap structure on the display tower, sealing a top end of the upright tubular configuration.

9. The windshield washing fluid dispenser for selectively filling a vehicle windshield washer reservoir, as defined by claim 1, wherein the fluid display tower is substantially transparent and of an upright tubular con figuration; and further comprising an overflow return fluid line opening into the fluid container and extending substantially coaxially within the tubular configuration of the display tower to a top end adjacent a top end of the display tower.

10. A process for dispensing windshield washing fluid dispenser directly to a vehicle having a windshield washing reservoir, comprising the steps of:
locating a windshield washing fluid display tower on a base housing at an elevation above the vehicle windshield washing reservoir;
supplying the fluid display tower with windshield washing fluid from a container within the base housing;
visually displaying the windshield washing fluid in the fluid display tower;
providing a filler hose leading from the windshield washer fluid display tower to a discharge end thereof;
extending the hose from the windshield washer fluid display tower to the vehicle windshield washer reservoir; and
opening a valve to permit flow of windshield washer fluid from the fluid display tower container and into the fluid reservoir.

11. A windshield washing fluid dispenser for selectively filling a vehicle windshield washer reservoir, comprising:
a hollow base housing;
a windshield washing fluid display tower comprised of an elongated cylindrical and at least substantially transparent tube mounted on the base housing and projecting upwardly therefrom to a top end;
a bulk windshield washing fluid container removably mounted below the display tower within the base housing;
a fluid pump assembly mounted within the base housing and including an intake line receivable within the fluid container and a discharge line extending to openly communicate with the windshield washing fluid display tower, and operable to at least partially fill the fluid display tower with windshield washing fluid from the fluid container to a selected level such that the windshield washing fluid is visible through the windshield washing fluid display tower;
an overflow tube substantially centrally located within the display tower with a top end adjacent the display tower top end, and a bottom end receivable within the fluid container;
a filler hose leading from the windshield washer fluid display tower to a discharge end, the hose being of sufficient length to extend from the windshield washer fluid display tower to the vehicle windshield washer reservoir; and
a valve in the filler hose and which is selectively operable to permit flow of windshield cleaner fluid from the washing fluid display tower and into a vehicle washer fluid reservoir; and wherein the washing fluid display tower is disposed by the base housing at an elevation within a range of between approximately 4 and 6 feet from a dispenser support surface such that windshield washing fluid will flow by gravity from the display tower to a vehicle windshield washer reservoir.
